(19) United States
(12) Patent Application Publication
(10) Pub. No.: US 2022/0065265 A1
(43) Pub. Date: Mar. 3, 2022

(54) ELECTRIC LIQUID PUMP

(71) Applicant: Johnson Electric International AG, Murten (CH)

(72) Inventors: Anbang CHEN, Shenzhen (CN); Guoyuan ZOU, Shenzhen (CN); Yi JING, Shenzhen (CN); Ruifeng QIN, Hong Kong (CN)

(21) Appl. No.: 17/523,387

(22) Filed: Nov. 10, 2021

Related U.S. Application Data
(63) Continuation of application No. PCT/CN2020/088977, filed on May 7, 2020.

(30) Foreign Application Priority Data
May 10, 2019 (CN) 201910388656.8

(51) Int. Cl. F04D 29/42; F04D 13/06; F04D 29/66; F04D 29/22

(52) U.S. Cl. CPC F04D 29/4293; F04D 29/22; F04D 29/669; F04D 13/06

(57) ABSTRACT

The disclosure relates to an electric liquid pump, comprising a pump housing, a motor connected to the pump housing, and an impeller housed in the pump housing and driven by the motor. The pump housing is provided with an inlet port and an outlet port. The impeller has an impeller inlet at the center thereof and an impeller outlet at a peripheral side thereof. The inlet port, the impeller inlet, the impeller outlet, and the outlet port are in flow connection sequentially. The inlet port comprises a columnar first segment and a second segment extending from the first segment. The second segment is close to the impeller inlet with a mouting seat formed therein. The impeller is sleeved on a rotation shaft. One end of the rotation shaft is engaged in the mounting seat. The impeller is rotatable relative to the mounting seat. The mounting seat is partially received in the impeller inlet. A gap between the mounting seat and an inner wall of the impeller inlet is defined as a flow passage for liquid.

### CROSS REFERENCE TO RELATED APPLICATIONS

This non-provisional patent application is a continuation application of PCT Application No. PCT/CN2020/088977, filed with the Chinese Patent Office on May 9, 2020, which claims priority to Chinese Patent Application No. 201910388656.8, filed on May 10 2019, all of which are incorporated herein by reference in their entirety.

### FIELD OF THE INVENTION

The invention relates to an electric liquid pump, in particular to an coolant pump for a vehicle.

### BACKGROUND

An electric liquid pump generally includes a pump housing, a motor connected to the pump housing, and an impeller housed in the pump housing and driven by the motor. The pump housing is provided with a columnar inlet port and a columnar outlet port. The motor includes a stator and a rotor rotatably installed in the stator. The rotor includes a rotation shaft and a rotor body surrounding the outer circumference of the rotation shaft, and the impeller is drivn to rotate via the rotation shaft. The impeller has an impeller inlet located in the center thereof and an impeller outlet located on the peripheral side thereof. The inlet port, the impeller inlet, the impeller outlet and the outlet port are in flow connection sequentially. In working of the electric liquid pump with afromentioned structur, liquid enters the inlet of the impeller from the inlet port, which generates large noise and poor performance.

### SUMMARY

It is the object of the present invention to provide an electric liquid pump with reduced the noise during operation of the electric liquid pump.

According to one aspect of the present invention, an electric liquid pump is provided. The electric liquid pump includes a pump housing, a motor connected to the pump housing, and an impeller housed in the pump housing and driven by the motor. The pump housing is provided with an inlet port and an outlet port. The impeller has an impeller inlet at the center thereof and an impeller outlet at a peripheral side thereof. The inlet port, the impeller inlet, the impeller outlet, and the outlet port are in flow connection sequentially. The inlet port comprises a columnar first segment and a second segment extending from the first segment. The second segment is close to the impeller inlet with a mouting seat formed therein. The impeller is sleeved on a rotation shaft. One end of the rotation shaft is engaged in the mounting seat. The impeller is rotatable relative to the mounting seat. The mounting seat is partially received in the impeller inlet. A gap between the mounting seat and an inner wall of the impeller inlet is defined as a flow passage for liquid.

Preferably, a ratio of a minimum width of the flow passage to an inner diameter of the first segment is greater than 23% and less than or equal to 35%.

Preferably, the ratio of a minimum width of the flow passage to an inner diameter of the first segment is greater than or equal to 25% and less than or equal to 35%.

Preferably, the ratio of a minimum width of the flow passage to an inner diameter of the first segment is 30%.

Preferably, a radial gap is formed between the impeller and an inner side wall of the pump housing, a ratio of a minimum value of a width of the radial gap to a diameter of the impeller is greater than 4% and less than or equal to 10%

Preferably, the ratio of the minimum value of the radial gap, which is formed between the impeller and an inner side wall of the pump housing, to the diameter of the impeller, is greater than or equal to 5% and less than or equal to 10%.

Preferably, the ratio of the minimum value of the radial gap, which is formed between the impeller and an inner side wall of the pump housing, to the diameter of the impeller, is 8%.

Preferably, the second segment of the inlet port of the pump housing is conical, with an inner diameter gradually increases in a direction away from the first segment, and a minimum value of the inner diameter of the second segment is equal to the inner diameter of the first segment.

Preferably, the impeller comprises an main body and a cover plate mounded on the main body, and the impeller inlet is defined in the cover plate.

Preferably, a plurality of ribs extends from an inner surface of the second segment to support the mounting seat, and the ribs are spaced from each other and arranged around the mounting seat.

The present invention can reduce the noise during the operation of the electric liquid pump and improve its working performance.

### BRIEF DESCRIPTION OF THE DRAWINGS

FIG. 1 is a perspective view of a fluid pump according to an embodiment of the present invention;

FIG. 2 is an exploded view of the electric liquid pump shown in FIG. 1;

FIG. 3 is a longitudinal section-view of the electric liquid pump shown in FIG. 1;

FIG. 4 is a bottom view of the pump housing of the electric liquid pump shown in FIG. 1;

FIG. 5 is a longitudinal section-view of the pump housing and impeller shown in FIG. 4;

FIG. 6 is a transverse section-view of the pump housing and impeller of the electric liquid pump shown in FIG. 1;

FIG. 7 is an exploded view of an impeller of the electric liquid pump shown in FIG. 1.

### DETAILED DESCRIPTION OF THE PREFERRED EMBODIMENTS

The present invention will be further described below based on the drawings and the embodiments.

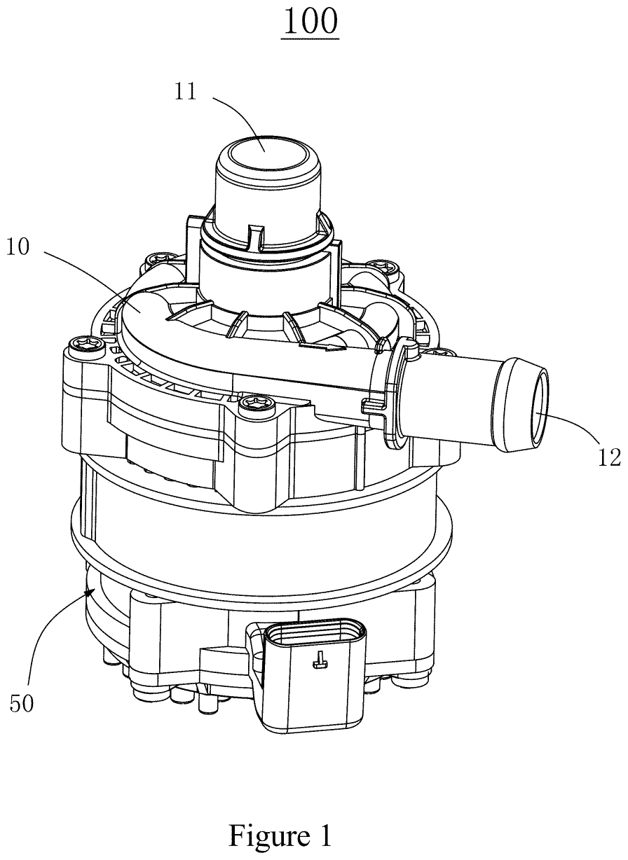

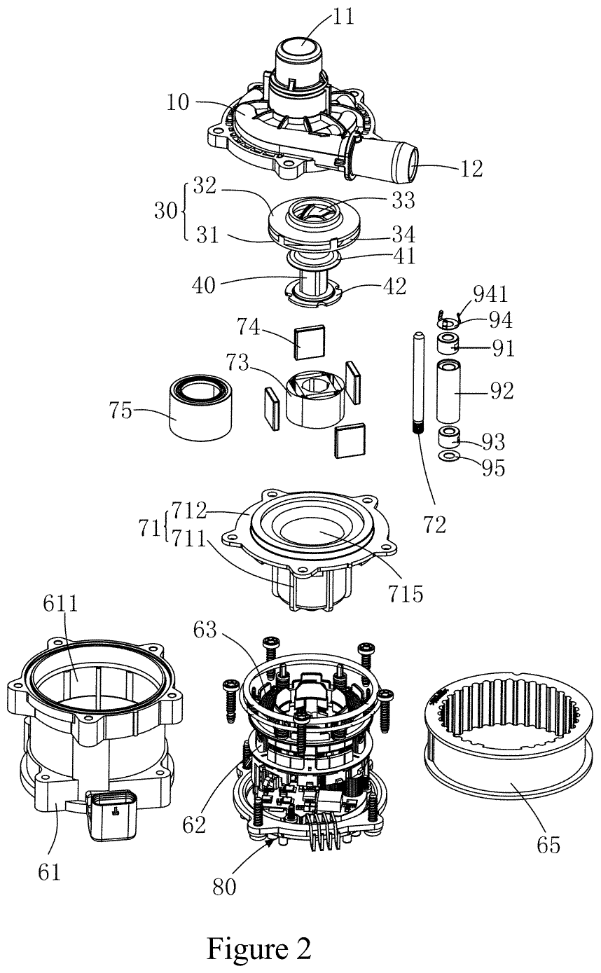

Referring to FIG. 1, an electric liquid pump 100 according to an embodiment of the present invention can be used as an automobile coolant pump. The electric liquid pump 100 includes a pump housing 10, a motor 50 connected to the pump housing 10, and an impeller 30 housed in the pump housing 10 and driven by the motor 50 (shown in FIG. 2). The pump housing 10 is provided with a inlet port 11 and a outlet port 12. The impeller 30 has an impeller inlet 33 at a center thereof and an impeller outlet 34 at a peripheral side thereof. The inlet port 11, the impeller inlet 33, and the impeller outlet 34 and the outlet port 12 are in flow connection sequentially. The motor 50 drives the impeller 30 to rotate when it is working, so that liquid enters the impeller 30 from the inlet port 11 and the impeller inlet 33, and then discharged outside from the impeller outlet 34 and the outlet port 12.

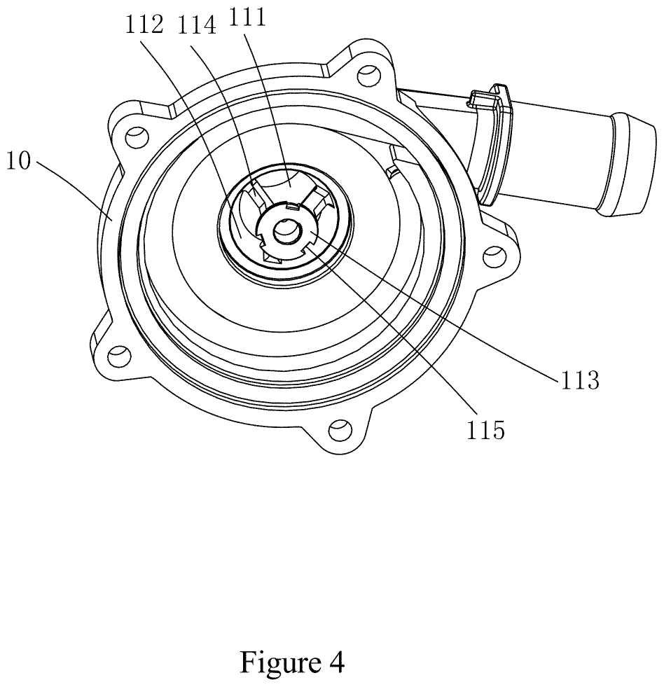

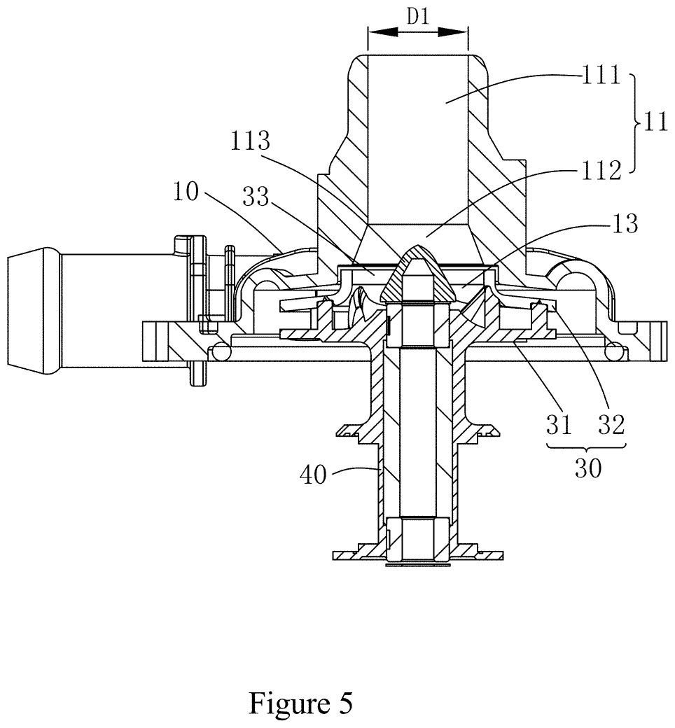

Referring to FIGS. 2 to 5, the motor 50 is an inner rotor motor, and includes a stator and a rotor rotatably installed in the stator. The stator includes a cylindrical stator housing 61, a cylindrical stator inner housing 71 housed in the stator housing 61, and a stator body arranged between the stator housing 61 and the stator inner housing 71. The stator body includes a stator core 62, a stator winding 63 wound to the stator core 62. The first end of the stator housing 61 is hermetically connected to the pump housing 10. The rotor is housed in the stator inner housing 71. The stator inner housing 71 includes a main body 711 with an open end and an flange 712 formed at the open end of the main body 711. The flange 712 is hermetically connected to the pump housing 10 and is clamped between the housing 61 and the first end of the pump housing 10. A pump chamber 104 is defined between flange 712 and the pump housing 10 to accommodate the impeller 30. The main body 711 is cylindrical, and defines an inner space 715 communicating with the pump chamber 104. The impeller 30 is adjactent to the open end of the main body 711. A fixed seat 714 is formed in the maim body 711 closed to the bottom of the inner space 715.

The rotor includes a rotation shaft 72 and a ring-shaped rotor body rotatable around the rotation shaft 72. The rotor body is integrated with a main body 31 of the impeller 30 through a connecting piece 40 as one a piece mmber. Preferably, the connecting member 40 is an injection-molded mebmer. The connecting piece 40 and the main body 31 are integrally injection-molded. The rotor body is fixedly sleeved to the outer circumference of the connecting member 40. The connecting piece 40 is sleeved on the rotation shaft 72. An end of the rotation shaft away from the impeller 30 is engaged into the fixing seat 714.

The inlet port 11 includes a columnar first segment 111 and a conical second segment 112 connected to the first segment 111. The second segment 112 is close to the impeller inlet 33 with a mouting seat 113 formed therein. The cross-sectional shape of the mounting seat 113 is preferably cone-shaped. The rotation shaft 72 passes through the impeller 30 and is engaged with the mounting seat 113. In work, when the motor 50 is energized, the rotor body rotates relative to the rotation shaft 72 under the action of the magnetic field of the stator core 62, to drive the impeller 30, through the connecting member 40, to rotate relative to the rotation shaft 72 and the mounting seat 113, thereby liquid being urged to enter the impeller 30 via the inlet port 11 and then the impeller inlet 33, and then discharging out of the pump from the impeller outlet 34 and the outlet port 12.

The impeller inlet 33 is aligned with the second segment 112. The mounting seat 113 is partially received in the impeller inlet 33. A gap between the mounting seat 113 and the inner wall of the impeller inlet 33 is defined as a flow passage 13 for the liquid. A ratio of a minimum width of the flow passage 13 to an inner diameter D1 of the first segment 111 is greater than 23% and less than or equal to 35%. Preferably, the ratio of the minimum width of the flow passage 13 to the inner diameter D1 of the first segment 111 is greater than or equal to 25% and less than or equal to 35%. Further preferably, the ratio of the minimum width of the flow passage 13 to the inner diameter D1 of the first segment 111 is 30%. Due to this configuration, when the electric liquid pump 100 works, a noise of the the electric liquid pump 100 generated with the liquid enterring the impeller 30 through the first segment 111, the second segment 112, and the flow passage 13, is reduced. The service life and the working performance are improved.

In this embodiment, the second segment 112 is conical, with an inner diameter gradually increaing in a direction away from the first segment 111. A minimum value of the inner diameter of the second segment 112 is equal to the inner diameter D1 of the first segment 111. This configuration can help to reduce the pressure exerted on the impeller 30 when liquid enters the impeller 30.

A plurality of ribs 114 extends from an inner surface of the second segment 112 to support the mounting seat 113. The ribs 114 are spaced from each other and arranged around the mounting seat 113. In the embodiment, there are three ribs 114.

Furtherly, the end of the rotation shaft 72 closed to the impeller 30 is sleeved with a upper bushing 91 rotatable relative to the rotation shaft 72. The main body 31 of the impeller 30 is fixedly engaged with the upper bushing 91. Preferably, the upper bushing 91 is integrated with the main body 31 by by insert molding.

The rotation shaft 72 is also sleeved with a bushing support 92 and a lower bushing 93 that can rotate relative to the rotation shaft 72. Opposite ends of the bushing support 92 respectively support the upper bushing 91 and the lower bushing 93. The lower bushing 93 is located at the end of the rotation shaft 72 away from the impeller 30, and adjacent to the fixing seat 714. A first washer 95 is interposed between the lower bushing 93 and the fixing seat 714 to prevent the fixing seat 714 from being worn out due to directly rubbing against the lower bushing. The connecting member 40 is fixedly sleeved to the bushing support 92 and the lower bushing 93. Preferably, the connecting member 40 is injection-molded around the bushing support 92 and the lower bushing 93. When the rotor body rotates under the action of the magnetic field of the stator core 62, the impeller 30, the upper bushing 91, the bushing support 92 and the lower bushing 93 can be driven to rotate relative to the rotation shaft 72 through the connecting member 40.

The impeller 30 includes the main body 31 and a cover plate 32 mounded on the main body 31. The impeller inlet 33 is defined in the cover plate 32. The mounting seat 113 is partially located in the impeller inlet 33. The main body 31 defines the impeller outlet 34.

A second washer 94 is sleeved on the end of the rotation shaft 72 near the impeller. The second washer 94 is located between the upper bushing 91 and the mounting seat 113 to prevent the mounting seat 113 from being worn out due to directly rubbing against the upper bushing 91. The second washer 94 includes a plurality of claws 941 to connecting with the mounting seat 113, and a part of the mounting seat 113 located in the impeller inlet 33 has a pluarity of grooves 115 for correspondingly engaging with the claws 941. Preferably, the number of claws 941 is three, and the number of grooves 115 is also three.

In one embodiment, the rotor body includes a rotor core 73, a pluraltiy of permanent magnets 74 embedded in the rotor core 73, and a protective sleeve 75 covering circumferential surface and opposite end surfaces of the rotor core 73. The permanent magnets 74 are square. In one embodiment, there are four permanent magnets 74 facing each other in pairs. The bushing support 92 and the lower bushing 93 are fixedly sleeved on the rotor core 73 through the connecting piece 40. The connecting member 40 includes a ring-shaped first connecting portions 41 and a second connecting portions 42 on outer periphery of the connecting member 40 and opposite to each other. The rotor core 73 is fixedly sleeved on the connecting member 40 and sandiwiched between the first connecting portion 41 and the second connecting portion 42. The first connecting portion 41 and the second connecting portion 42 are respectively fixed to oppsite ends of the protective sleeve 75, thereby fixing the rotor body to the connecting piece 40.

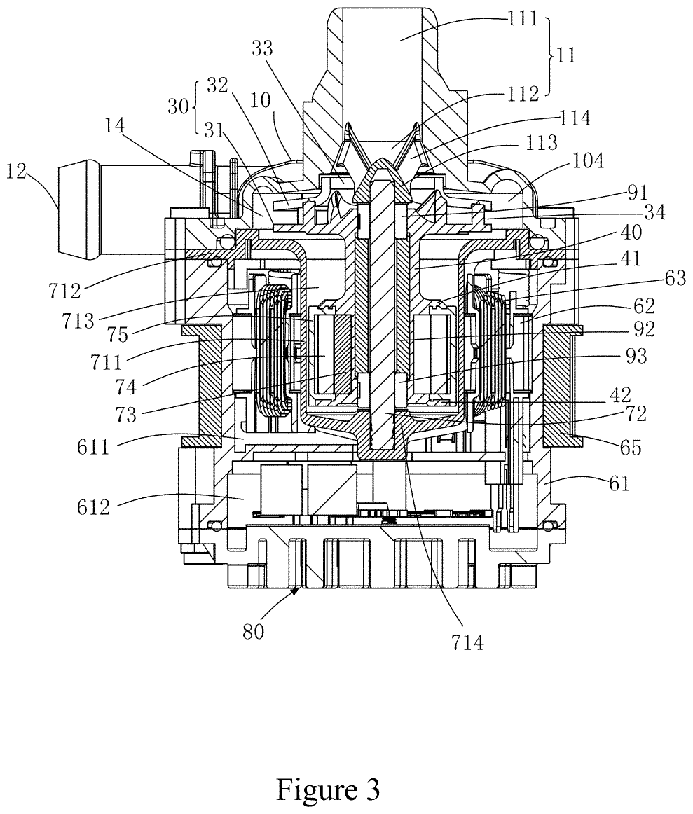

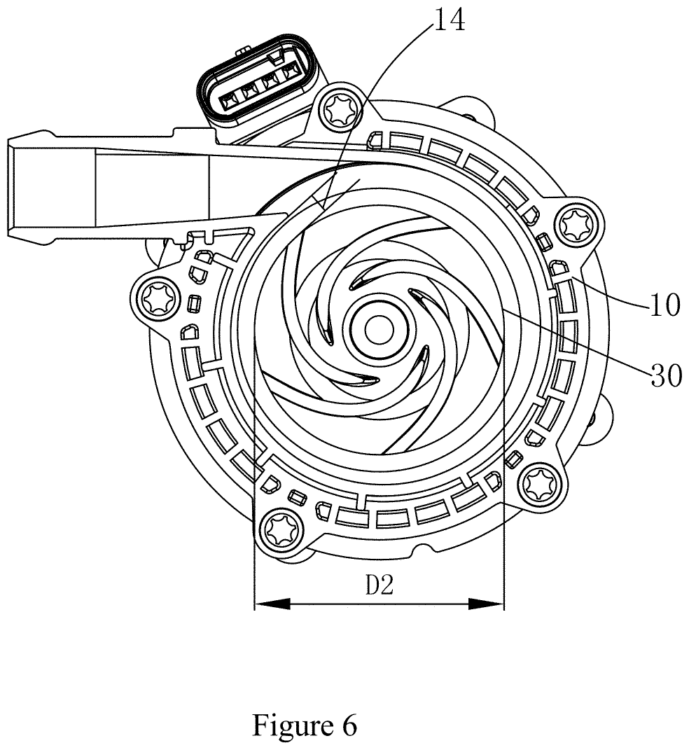

Referring to FIGS. 3 and 6, there is a radial gap 14 between the impeller 30 and an inner sidewall of the pump housing 10. A width of the radial gap 14 is defined as a distance between the inner wall of the pump housing 10 and a peripheral side of the impeller 30 along a radial direction of the impeller 30. The ratio of a minimum value of the width of the radial gap 14 to a diameter D2 of the impeller 30 is greater than 4% and less than or equal to 10%. Preferably, the ratio of the minimum value of the width of the radial gap 14 to the diameter D2 of the impeller 30 is greater than or equal to 5% and less than or equal to 10%. Further preferably, the ratio is 8%. In one embodiment, the pump housing 10 is a volute casing. Therefore, the minimum value of the width of the radial gap 14 should be the radial width between the starting point of the volute profile of the pump housing 10 and the peripheral side of the impeller 30. Based on this configuration, when the electric liquid pump 100 words, liquid can flows to the outlet port 12 via the impeller outlet 34 and the radial gap 14 with low noise, so that noise of the electric liquid pump 100 can also be reduced.

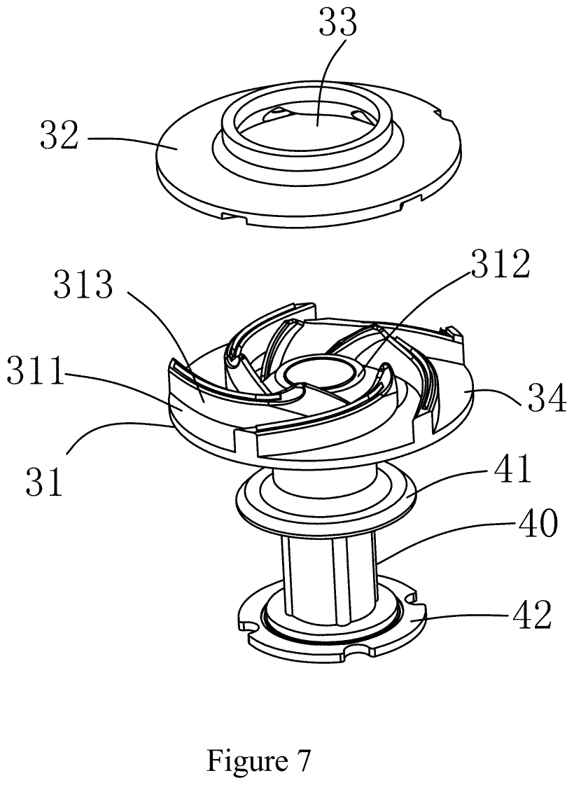

Referring to FIGS. 2 and 7, the main body 31 of the inpeller 30 includes a bottom plate 311, a hub 312 located at the center of the bottom plate 311, and a plurality of arc-shaped blades 313 extending from the hub 312 to the outer periphery of the bottom plate 311. The arc-shaped blades 313 are arranged on the bottom plate 311 at intervals and located between the bottom plate 311 and the cover plate 32. The hub 312 is injection molded onto the upper bushing 91. The center of the cover plate 32 has the impeller inlet 33, and the impeller outlet 34 is formed between the radially outer ends of two adjacent arc-shaped blades 313.

Referring to FIG. 2 and FIG. 3 again, the stator housing 61 is sleeved by a a plastic bracket 65 to protect the stator housing 61. A first chamber 611 and a second chamber 612 are formed in the stator housing 61 and arranged axially. The stator core 62 and the stator inner housing 71 are installed in the first chamber 611. A drive circuit 80 is installed at one end of the stator housing 61 and received in the second chamber 612. The drive circuit 80 is electrically connected to the stator winding 63 for power supply of the stator winding 63.

Since the stator inner casing 71 and the pump housing 10 is hermetically connected, the first chamber 611, the stator core 62, the second chamber 612 and the drive circuit 80 will not be soaked by the liquid in the inner space 715 of the stator inner housing 71 and the pump chamber 104 to prevent the stator or the drive circuit 80 from be damaged by the liquid.

In one embodiment, the main body 711 of the stator inner housing 71 is located in a space enclosed by a number of stator teeth of the stator core 62. The flange 712 of the stator inner housing 71 rests on the end of the stator housing 61 closed to the first chamber 611. The pump housing 10 and the flange 712 are sequentially fixed to the stator housing 61 with fasteners such as screws, The configuration is convenient for disassembly and assembly.

Although certain inventive embodiments of the present disclosure have been specifically described, the present disclosure is not to be construed as being limited thereto. Various changes or modifications may be made to the present disclosure without departing from the scope and spirit of the present disclosure.

1. An electric liquid pump comprising a pump housing, a motor connected to the pump housing, and an impeller housed in the pump housing and driven by the motor;
the pump housing being provided with an inlet port and an outlet port; the impeller has an impeller inlet at the center thereof and an impeller outlet at a peripheral side thereof, the inlet port, the impeller inlet, the impeller outlet, and the outlet port being in flow connection sequentially, characterized in that: the inlet port comprises a columnar first segment and a second segment extending from the first segment, the second segment is close to the impeller inlet with a mouting seat formed therein; the impeller is sleeved on a rotation shaft, one end of the rotation shaft is engaged in the mounting seat, and the impeller is rotatable relative to the mounting seat; the mounting seat is partially received in the impeller inlet, a gap between the mounting seat and an inner wall of the impeller inlet is defined as a flow passage for liquid.

2. The electric liquid pump according to claim 1, wherein a ratio of a minimum width of the flow passage to an inner diameter of the first segment is greater than 23% and less than or equal to 35%.

3. The electric liquid pump according to claim 2, wherein the ratio of a minimum width of the flow passage to an inner diameter of the first segment is greater than or equal to 25% and less than or equal to 35%.

4. The electric liquid pump according to claim 3, wherein the ratio of a minimum width of the flow passage to an inner diameter of the first segment is 30%.

5. The electric liquid pump according to claim 1, wherein a radial gap is formed between the impeller and an inner side wall of the pump housing, a ratio of a minimum value of a width of the radial gap to a diameter of the impeller is greater than 4% and less than or equal to 10%

6. The electric liquid pump according to claim 5, wherein the ratio of the minimum value of the radial gap, which is formed between the impeller and an inner side wall of the pump housing, to the diameter of the impeller, is greater than or equal to 5% and less than or equal to 10%.

7. The electric liquid pump according to claim 6, wherein the ratio of the minimum value of the radial gap, which is formed between the impeller and an inner side wall of the pump housing, to the diameter of the impeller, is 8%.

8. The electric liquid pump according to claim 1, wherein the second segment of the inlet port of the pump housing is conical, with an inner diameter gradually increases in a direction away from the first segment, and a minimum value of the inner diameter of the second segment is equal to the inner diameter of the first segment.

9. The electric liquid pump according to claim 1, wherein the impeller comprises a main body and a cover plate mounded on the main body, and the impeller inlet is defined in the cover plate.

10. The electric liquid pump according to claim 1, wherein a plurality of ribs extends from an inner surface of the second segment to support the mounting seat, and the ribs are spaced from each other and arranged around the mounting seat.
